(19) United States
(12) Patent Application Publication
(10) Pub. No.: US 2008/0191072 A1
(43) Pub. Date: Aug. 14, 2008

(54) Multi-Stage Agitator Mill

(76) Inventor: Gisbert Schall, Park Ridge, NJ (US)

Correspondence Address: SCHWEITZER CORNMAN GROSS & BONDELL LLP, 292 MADISON AVENUE - 19th FLOOR, NEW YORK, NY, 10017, US

(21) Appl. No.: 11/912,398

(22) PCT Filed: Apr. 25, 2006
(86) PCT No.: PCT/US2006/015519

§ 371 Date: Oct. 24, 2007

Related U.S. Application Data
(60) Provisional application No. 60/674,725, filed on Apr. 25, 2005.

(51) Int. Cl. B02C 9/04; B02C 23/06; B02C 15/00; B02C 13/00

(52) U.S. Cl. 241/36; 241/16; 241/162; 241/70

(57) ABSTRACT

A grinding mill has an outer housing and a rotor mounted in the housing to form a grinding zone between the housing and rotor into which a charge to be ground is introduced. A pair of spaced rings are located at the entranceway to the grinding zone to form an annular gap through which the charge passes. At least one of the rings is adjustable to vary the gap width in response to one or more mill operating parameters. The rings control the flow of the charge into the grinding zone and reduce the size of the charge particles before they enter the grinding zone.

The present invention relates to a multi-stage agitator mill for milling or grinding flowable mill charges. The present application claims the benefit of Provisional Application 60/674,725 filed Apr. 25, 2005.

### BACKGROUND OF THE INVENTION

As set forth in U.S. Pat. No. 5,894,998 to the present inventor, agitator mills are utilized to grind or reduce materials into a uniform, typically fine, such as submicron, particle size. An outer cylindrical grinding container is provided, along with a co-axial, cylindrical inner stator. A cylindrical grinding area is thus formed between the container and stator. A generally cup-shaped rotor is mounted co-axially to the container and stator, its rotor base or head being positioned in the vicinity of a cover for the grinding container, with the cylindrical portion of the rotor mounted to the head. The cylindrical rotor portion extends into the grinding area formed between the grinding container and inner stator, thus dividing the grinding area into a pair of cylindrical, co-axial outer and inner grinding areas. The outer grinding area is defined between the outer surface of the rotor and the inner surface of the container, while the inner grinding area is defined between the inner surface of the rotor and the outer surface of the inner stator. The two grinding areas are hydraulically connected through a lower connecting area below the rotor.

A mill charge is fed into the outer grinding area in the form of a slurry under slight pressure. Upon entry into the outer grinding area, it mixes with a grinding material, typically in the form of grinding beads or auxiliary grinding bodies of ceramic, glass, steel or the like. The mill charge and grinding beads flow downwardly through the outer grinding area where they are agitated and mixed together by agitating elements located on the container and rotor surfaces. The mill charge and grinding beads flow through the outer grinding area, through the lower connecting area, and then upwardly in the inner grinding area where the charge and bead mix is further processed and agitated. A separating screen at the upper end of the inner grinding area allows the fine fractions of the charge to pass through the separating screen into a discharge device, which can be of rotating design or the more commonly used stationary design, not shown in the '998 patent, but as also known in the art, while the grinding beads and remaining coarse mill charge fractions pass through radially-directed overflow ducts back into the outer grinding area where they mix with newly introduced feed stock and are recycled through the mill.

As such grinding mills typically accept and process a variety of charge materials, the operating parameters of a mill may be subject to constant adjustment. Because the charge is provided under a slight pressure, overloading of the mill can occur, ultimately resulting in clogging or “blinding” of the discharge screen, and requiring down time for clearance. Apart from the blinding problem, efficient mill operation requires control over the flow rate of the charge for optimum discharge rates. The introduction of comparatively large charge fractions can substantially lengthen the overall residence time for a charge, thus lessening throughput.

It is accordingly an object of the present invention to provide a multi-stage agitator mill that can process a variety of coarse products and reduce them to the necessary degree of fineness.

A further object of the present invention is to provide a multi-stage agitator mill having a pre-grinding or pre-dispersing zone in which coarse charge materials are broken down before finer grinding or milling.

Yet a further object of the present invention is to provide a multi-stage agitator mill having a pre-grinding stage, the throughput of which is controllable.

A still further object of the present invention is to provide a multi-stage agitator mill having an adjustable inlet to accommodate charge materials of varying sizes and flow rates.

### BRIEF DESCRIPTION OF THE INVENTION

In accordance with the foregoing and other objects and purposes, a multi-stage agitator mill in accordance with the present invention comprises concentric first and second grinding areas joined at the lower end of a rotating rotor. Positioned at the entrance to the first grinding area is an entryway or inlet having an adjustable throat between fixed and rotating throat elements, the spacing between the elements being controlled by the mill operator to be responsive to the nature of the material charged to the ground. The inlet throat size may be controlled automatically, responsive to sensed conditions associated with the grinding process, may be manually adjusted by a mill operator, or may have a preset response. The throat may have at least one surface of an appropriate abrasive material to cause an initial grind of the charge before it enters the first grinding area. The mill may further be provided with vanes in at least one of the grinding areas to assist in directing the charge flow through the mill.

### BRIEF DESCRIPTION OF THE DRAWINGS

A fuller understanding of the present invention will be attained upon consideration of the follow detailed description of a preferred, but nonetheless illustrative, embodiment of the invention, when reviewed in association with the annexed drawings, wherein:

FIG. 1 is a vertical section through an agitator mill of the present invention; and

FIG. 2 is an enlarged view of the adjustable throat portion of the agitator mill.

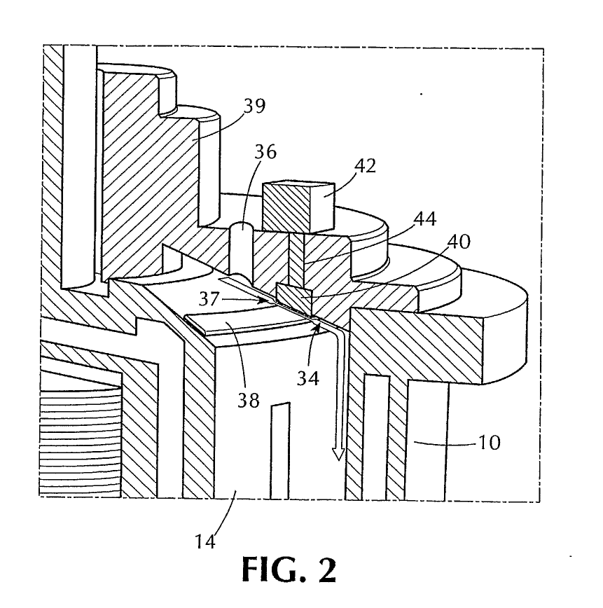

### DETAILED DESCRIPTION OF THE INVENTION

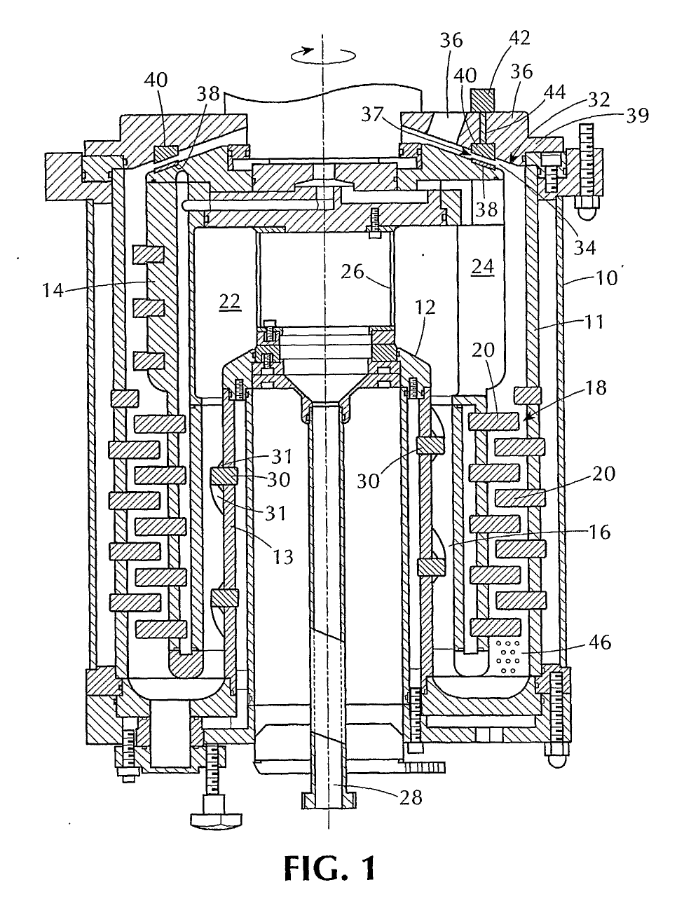

An agitator mill of the present invention is depicted in FIG. 1. The mill has an outer cylindrical grinding container 10 and inner stator 12. Rotor 14 extends into the space between the inner wall 11 of container 10 and stator 12, forming a cylindrical outer grinding area 18 and a cylindrical inner grinding area 16. Located both on the container wall and the outer surface of rotor 14 are agitating means, such as pegs, pins or bolts 20, to bring about a thorough mixing of the mill charge and grinding media 46. After flowing downwardly through the outer grinding area 18 and subsequently upwardly through the inner grinding area 16, the charge passes into an expansion area 22. The grinding beads or auxiliary grinding bodies and coarse mill charge fractions pass back to the outer grinding area 18 through an overflow duct 24, while the mill charge fines pass radially inward through separating screen 26 into a discharge device 28.

Inner stator 12 is provided with a series of media acceleration vanes 30 which are at an angle to the horizontal and which are oriented to assist in causing a flow of the charge upwardly through the inner grinding area 16 in conjunction with the rotation imparted to the charge by the rotor 14. In addition, frictional grinding apparatus 32, positioned at the entranceway 34 to the outer grinding area 18, is provided to both control the flow of the charge into the outer grinding area and reduce the initial size of the charge being processed prior to grinding of the charge by the grinding stages of the apparatus and use of the grinding media 46.

The grinding charge is introduced into the mill by a pump (not shown) through inlet 36 to entranceway 34. Immediately after entering the mill, the product distributes itself radially symmetrically between the cover 39 of the mill and the top of the rotor 14 due to the rotor's rotation, and is directed into the pre-grinding apparatus generally shown at 32. The apparatus 32 consists of a rotating ring 38 mounted to the top 15 of the rotor 14, and a stationary ring 40 mounted to the mill cover 39 to form an annular frictional suction gap 37. The position of stationary ring 40 with respect to the rotating ring is controlled by controller 42, connected to the ring 40 by control means 44. The rotating and stationery rings define a neck or passageway between them, the controller 42 raising or lowering the position of the stationary ring 40 to adjust the neck spacing between the rotating and stationary ring and thus the size of the annular frictional suction gap, and controls the flow of the charge material into the grinding areas of the mill as well as performing a pre-grind of the charge.

In automated mill environments, the gap can be adjusted on an automatic basis, opening and closing as a result of sensing of product flow rate, inlet pressure, processing temperature, mill rotor speed, mill power consumption, or combinations of such or other factors. Ring controller 42 may include appropriate processing circuitry for receipt of data associated with the variable factors and combining them in an appropriate manner. Alternatively, analysis of such factors and generation of an appropriate operating signal may be performed remotely, the resulting control signal being provided to the controller 42 which, in turn, controls stationary ring through control means 44. The control means 44 may be in the form of a rigid connection, such as a drive rod, between the controller and stationary ring, or may be in the form of a hydraulic or pneumatic drive or the like. The ring controller and control means may also be in the form of an adjustable spring or other positioning element able to be controlled manually.

The rings 38 and 40 may be of any appropriate material to provide the desired pre-grinding function. As such, preferred surfaces are either metallic or ceramic formulations, which may be replaceable. In addition, the surfaces can be provided with appropriate contouring and configurations to further enhance pre-grinding and dispersion functions of the charge passing therebetween.

In addition to providing an initial grind function, the rings allow for the control of passage of charge into the mill. Thus, in particular circumstances, the choice of surface may be chosen to minimize pre-grinding, if appropriate, the positioning of the rings being primarily to control charge flow.

After passing through the gap, the dispersed and processed charge combines with grinding media and passes through the mill in a conventional manner. As the charge and grinding media flows upwardly through the inner grinding area 16, however, it is exposed to strong, upwardly directed forces created by the induced contact with the vanes 30, which act as media acceleration segments. The accelerated flow through the inner zone enhances the grinding process and further improves the flow characteristics of the mill.

As shown in FIG. 1, the vanes 30, shown in section, each include a curved transition section 31 between the vertical inner stator wall 13 and the generally horizontally-extruding vane surfaces. The transition sections prevent the formation of dead zones at the base of the vanes which could accumulate grinding bodies, charge or debris that could adversely affect the performance of the mill.

When mills of the present invention are used in a re-circulating mode with a reservoir of material to be processed, such as printing inks or industrial or automotive coatings, the pre-grinding apparatus may initially be in a relatively closed position, and can be opened in response to the particle size of the material in the reservoir. This can allow for higher product flow rates through the mill as may be appropriate without restriction from the annular frictional suction gap. This flow rate or motion is further improved through the action of the media acceleration vanes 30.

I claim:

1. A grinding mill, comprising an outer housing and a rotor mounted therein to form a grinding zone, an entranceway to the grinding zone, and an annular frictional suction gap located at the entranceway formed between a stationary ring and a rotating ring, and means associated with at least one of the rings to adjust the width of the gap.

2. The grinding mill of claim 1 wherein at least one of the rings has an abrasive surface.

3. The grinding mill of claim 2 wherein the adjusting means comprise a controller coupled to control means.

4. The grinding mill of claim 1 wherein the stationary ring is mounted to a cover for the outer housing and the rotating ring is mounted to the rotor.

5. The grinding mill of claim 1 further including charge-directing vanes located in the grinding zone.

6. The grinding mill of claim 5 wherein the rotor is of cylindrical construction and a stator is located within the outer housing to positioned to define a second grinding zone between the stator and an inner surface of the rotor, the charge-directing vanes being located on the stator.

7. The grinding mill of claim 3 wherein the controller is responsive to at least one of product flow rate, inlet pressure, processing temperature, mill rotor speed, and mill power consumption.

8. The grinding mill of claim 3 wherein the controller and control means are manually adjustable.

9. A method for improving the performance of a grinding mill comprising an outer housing and a rotor mounted therein to form a grinding zone, an entranceway to the grinding zone, comprising the mounting of an annular frictional suction gap formed between a stationary ring and a rotating ring at the entranceway and adjusting the width of the gap in reliance of an operating parameter of the mill.

10. The method of claim 9, wherein the width adjustment is performed by varying the position of the stationary ring.

11. The method of claim 9 further comprising the step of reducing the size of charge particles in a pre-grinding step by providing an abrasive surface on at least one on the rings and passing the charge through the annual frictional suction gap.

12. In a grinding mill of the type comprising an outer housing and a rotor mounted therein to form a grinding zone with an entranceway to the grinding zone, the improvement comprising a stationary ring and a rotating ring located at the entranceway to form an annular frictional suction gap therebetween, and means associated with at least one of the rings to adjust the width of the gap.

13. The improvement of claim 12 further comprising charge-directing vanes located in the grinding zone.
